(19) United States
(12) Patent Application Publication
(10) Pub. No.: US 2011/0206447 A1
(43) Pub. Date: Aug. 25, 2011

(54) ATTACHMENT ELEMENT FOR FASTENING OF ATTACHMENT PARTS TO THE INSIDE WALL OF A TOWER OF A WIND ENERGY SYSTEM

(76) Inventors: Ulrich Uphues, Rheine (DE); Lorenz Meesenburg, Bremen (DE)

(21) Appl. No.: 13/126,276

(22) PCT Filed: Dec. 16, 2009
(86) PCT No.: PCT/EP2009/067262

§ 371 Date: Apr. 27, 2011

(30) Foreign Application Priority Data
Nov. 19, 2008 (DE) 10 2008 058 229.8

(51) Int. Cl. F03D 11/00; F16B 11/00

(52) U.S. Cl. 403/266

(57) ABSTRACT

In order to provide an attachment element for fastening of attachment parts (P) to a metal inner tower wall (T) of a tower of a wind energy system, comprising a first end side for welding to the inner tower wall (T) and a second end side for fastening an attachment part (P), said second side opposite the first end side, wherein the resultant weld connection between said attachment element and the tower wall is under a reduced stress, thereby enabling the connection point to be assigned to a higher fatigue class, it is proposed that such an attachment part have a total cross-sectional material thickness that is reduced near the first end side in comparison to a total material thickness in a cross-section shifted toward the second end side.

### FIELD OF THE INVENTION

The invention relates to an attachment element for fastening attachment parts to an inner tower wall of a wind energy system, as defined by the characteristics of the preamble to claim 1.

### PRIOR ART

Wind energy systems are tall erected constructions, whose current-generating components are disposed on the upper end of a tower extending to a great height, in a machine house situated there. Not only because of the great loads from the weight of the components disposed in the machines but also because of other loads, especially the back-pressure of the oncoming wind, the towers of wind energy systems are exposed to heavy stresses. This is all the more true since modern wind energy systems, with ever-greater power levels, have to be built larger and thus taller.

Besides a mode of construction in which the tower of a wind energy system is built of reinforced steel concrete, towers of wind energy systems are often formed of screwed-together or otherwise-joined annular metal elements, typically steel elements. In the interior of the tower, for instance to make it man-accessible at various levels or to brace components, attachment parts must be provided and fastened to the inner tower wall. In principle, it would be conceivable and possible for such fastenings to be made by making openings in the tower wall and passing screws, rivets, or the like through them, or to weld attachment components, such as platforms to be mounted for instance in the tower interior at various heights, directly to the tower wall. However, openings in the tower wall, particularly, but also direct welded connections to relatively large-sized attachment elements, such as platforms, cause weakening of the tower wall in the vicinity of the connecting point, which reduces the overall stability of the tower. To absorb and compensate for such a reduction in stability, the tower wall must then be embodied with a correspondingly greater thickness, which is undesirable, not only because of the higher material costs but also because of the increased weight and the attendant subsequent costs in shipping and setting up the system as well as in designing the foundation, and the like.

For that reason, even today, special attachment elements in the form of so-called welded-in bushings are used, for instance for securing man-accessible platforms to the inner tower wall.

One such connection in accordance with the prior art is shown in FIG. 1. A welded-in bushing 1 is an essentially cylindrical element with a central bore 2 of constant diameter. The central bore 2 is provided with a female thread 3. This welded-in bushing 1 is placed with one face end against the tower wall T and welded to the tower wall T by making a weld seam 4. This welding is done by means of adding material, for instance via a welding wire. On the face end of the welded-in bushing 1 opposite the weld seam 4, an angle W can now be fastened to a first leg by means of a screw S. On the second leg of the angle W, essentially perpendicular to the first leg, an attachment part, such as a platform P, is then placed and joined to the angle W in a suitable way, for instance being welded, screwed, riveted, or the like.

A mode of construction of this kind has the advantage that peak loads in particular, which bear on the attachment part, such as the platform P, and from it are introduced into the tower wall T via the connecting construction, do not bear entirely on the tower wall T but instead are weakened and absorbed by the flexibility of the angle W. The weakening of the tower wall T thus occurring at the weld seam 4 is less than in a case in which the platform P, for instance, were to be welded directly to the tower wall T.

Such a construction has proved itself in use, and according to DIN it was permissible, for calculating the tower wall at the connection point of the weld seam 4, to assume a notch fatigue class 90.

In recent development, however, it has been found that this assumption is not readily possible, and particularly within the scope of a new European standard, EN 1993-1-9, a change was made. In that standard, in Table 8.4, last line, it is now the rule that in such a connection, a notch fatigue class 90 cannot simply be assumed; instead, typically a notch fatigue class 80 should be expected. However, that means that in designing the tower, the tower wall T must be made correspondingly thicker, with the aforementioned consequences and disadvantages. The aforementioned European standard does allow a better notch fatigue class to be expected, if such a notch fatigue class can in fact be documented. However, such a notch fatigue class can be documented only if the introduced loads, in particular peak loads, of an attachment part joined to the inner tower wall via a suitable attachment element can be even better absorbed, and if the loads are not introduced into the tower wall or into the connection represented by the weld seam 4.

### SUMMARY OF THE INVENTION

Accordingly, it is the object to find an attachment element having the characteristics of the preamble to claim 1 which makes a lesser stress on the welded connection existing between this attachment element and the tower wall and thus makes it possible to put this connection point in a higher notch fatigue class.

It has been found that this object can be attained by means of an attachment element for fastening attachment parts to a metal inner tower wall of a tower of a wind energy system having the characteristics of claim 1. Advantageous refinements of such an attachment element are recited in dependent claims 2 through 6. Finally, in claim 7, an improved tower of a wind energy system is recited, on which at least one attachment element of the type according to the invention is welded to its inner wall.

The essential discovery of the invention is that incident peak loads, in particular, can be flexibly absorbed by an attachment element according to the invention, and these loads can be prevented from impacting the welded connection of the inner tower wall, if the attachment part in cross section, in the vicinity of the first face end of the attachment element face end to be welded to the inner tower wall, has a total material thickness that is less than a total material thickness in a cross section that is closer to the second face end.

By means of such a reduction in the total material thickness, an intentional weakening of the attachment element in the vicinity of the connection with the inner tower wall is created, which lends the attachment element a measure of flexibility that is capable in particular of absorbing or cushioning peak loads, as a result of which these peak loads are not introduced into the welded connection between the attachment element and the inner tower wall. In this way, the stress on the inner tower wall in the vicinity of the welded connection or on the welded connection itself can thus be reduced, so that an increase and in that sense an improvement in the actual notch fatigue class can be attained. The inventors have proven that with a suitable design, it is thus possible to expect a notch fatigue class 90 at the point of this welded connection to the inner tower wall, instead of the notch fatigue class 80 that is as a rule demanded by the European standard. Accordingly, the design of the thickness of the tower wall can be made less, with the attendant advantages of economy of material and further possibilities for economy of cost.

The attachment element can have any possible shape; unlike in the prior art, it can be essentially solid instead of bushing-like, or can have blind bores into one or both face ends. The outside diameter of the attachment element can be continuously constant, and the attachment element can also be cylindrical; the outside diameter can equally well vary, for instance having an offset. All that is important is that compared with a total existing material thickness, in cross section in the vicinity of the first face end, in the direction of the second face end there is a cross section which has a higher or greater total material thickness than the total material thickness in the vicinity of the cross section of the first face end.

The attachment parts to be fastened can be fastened to the attachment element in an arbitrary way. They can either bear directly on the attachment element or can bear on it via interposed elements, such as the angles used in the prior art. The part to be secured to the attachment element itself can be screwed, welded or in some other way joined to it.

To ensure compatibility with the welded-in bushings used until now as standard parts and with the other connecting elements for attaching the attachment parts, it is preferred that as much as possible the attachment element of the invention be embodied in agreement with the previously known welded-in bushings. Thus the outside dimensions in particular can remain continuously the same from the first to the second face end, and the attachment element can have a continuous longitudinal bore. This longitudinal bore, in the vicinity of the first face end, is advantageously provided with a portion of widened diameter. This widened diameter is especially advantageously extended over at least ⅓ of the total length of the attachment part, measured as the spacing from the first face end to the second face end. By means of such a comparatively long guidance of the widened bore in the vicinity of the first face end, the desired additional flexibility for absorbing peak loads can be obtained especially reliably.

On the second face end, an attachment element of the invention can advantageously have a female thread, into which a screw that is usual for that connecting technique can be guided.

### BRIEF DESCRIPTION OF THE DRAWINGS

Further advantages and characteristics of the invention will become apparent from the ensuing description of an exemplary embodiment in conjunction with the drawings. In the drawings:

FIG. 1 schematically shows an attachment construction for fastening an attachment part to the inner wall of the tower of a wind energy system, with a welded-in bushing in accordance with the prior art;

FIG. 2, in a comparable illustration to FIG. 1, shows such a construction with an attachment element of the invention, in one possible embodiment;

FIG. 3, in an illustration, shows a wall of an attachment element of FIG. 2 according to the invention, indicating dimensions and showing the fastening to an inner tower wall; and

FIG. 4 shows further possibilities of embodiment for attachment elements according to the invention in their disposition on the inner tower wall of a wind energy system.

### WAY(S) FOR EMBODYING THE INVENTION

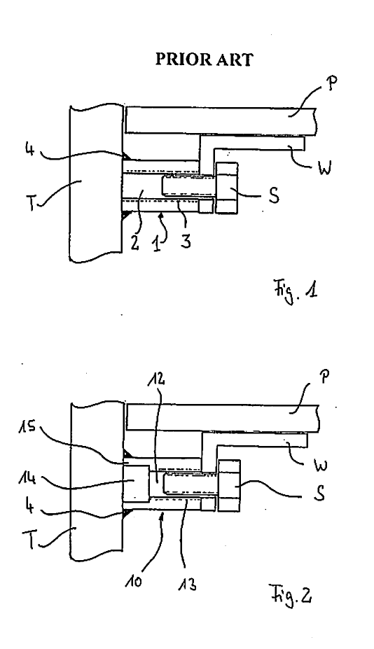

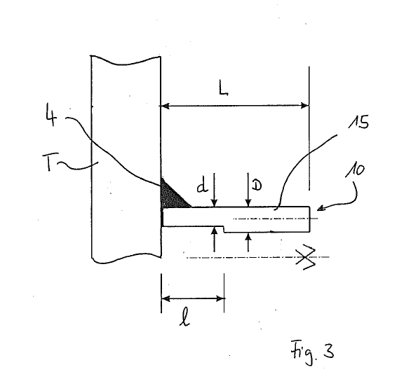

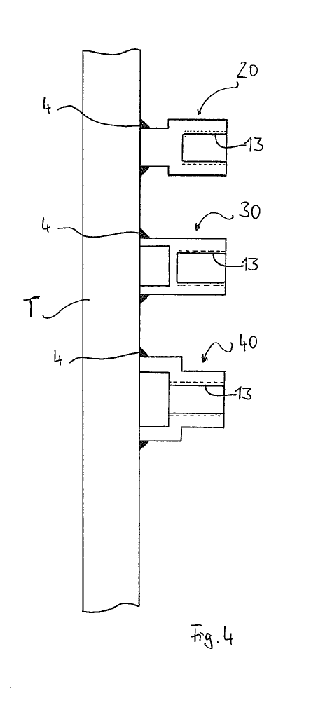

FIG. 1, already discussed as prior art at the outset, shows a known attachment to a tower. FIGS. 2 and 3 show a first exemplary embodiment for an attachment element of the invention; in FIG. 4, further possible variants are shown.

The first exemplary embodiment, shown in FIGS. 2 and 3, of an attachment element 10 according to the invention is formed essentially similarly to the welded-in bushing 1 known from the prior art. The attachment element 10 is likewise constructed essentially cylindrically, with an outer contour that is preferably circular in cross section. It has constant outside dimensions over its length as well as a central bore extending in the interior in the longitudinal direction of the attachment element 10. In a first face end, at which the attachment element 10 is joined to the tower wall T via a weld seam 4, or in the as yet not built-in state is intended for connection of that type, the central bore 12 in a portion 14 is provided with a widening and thus here as well has a larger diameter. However, as a result, the wall 15 in this portion is weakened compared to the thickness outside that portion and is of lesser thickness. The total thickness of the wall in a cross section is thus less than in a cross section, shifted in the direction of the end of the built-in element 10 opposite the first face end, through a region in which the bore 12 has the lesser diameter.

In the vicinity of the second face end, opposite the first face end, the central bore 12 is provided with a female thread 13 for screwing in a screw S of the kind also used in the prior art.

The weld seam 4 extends outward around the outer wall of the attachment element 10 and is produced by a classical welding method by adding material (for instance by means of a welding wire).

In FIG. 2, the attachment element 10 of the invention is shown in a comparable construction to the prior art, with an angle element W screwed to the attachment element 10 and with the platform P laid on the angle element. It is understood that here as well, still other securing methods could be chosen. What is decisive is that as a result of the intentional weakening of the material of the attachment element 10 in the vicinity of the first face end, greater flexibility in the connecting structure is created, which reduces the abrupt change in stiffness in the storm shell and thus justifies its classification in a higher notch fatigue class.

In FIG. 3, in an enlarged view, only a portion of the wall 15 of the attachment element 10 of the invention is shown as it is fastened at a weld seam 4 on the tower wall T. In the drawing, various dimensions are shown as variables; that is, the total length L of the attachment element 10 and the length l of the portion with the widened bore. Also shown there are the wall thickness D in the vicinity of the non-widened bore as well as the reduced wall thickness d in the vicinity of the widened bore.

In one exemplary embodiment, the total length L of a usable attachment element 10 is for instance 35 mm; the length l of the portion with the widened bore is 15 mm. The outside diameter of the attachment element 10 of circular cross section is 30 mm; in the vicinity of the face end opposite the weld seam 4, an M16 female thread is made in the non-widened bore. The wall thickness D is thus approximately 7 mm, and the reduced wall thickness d is this exemplary embodiment is defined as 5 mm.

These dimensions and values can naturally vary, depending on the intended use.

Finally, in FIG. 4, further examples are shown of attachment elements 20, 30 and 40 according to the invention, showing how they are fastened to an inner tower wall T via weld seams 4 which are likewise produced by means of a classical welding method by adding material and which extend on the outside around the outer wall of the respective attachment element 20, 30, 40. A common feature of all the further attachment elements 20, 30 and 40 shown here is a bore, made on the second face end away from the tower wall and having a female thread 3. Screws can be received in this bore in the usual way.

In addition, all the attachment elements 20, 30 and 40 shown have a cross section, on the first face end fastened to the tower wall T via the weld seam 4, with a lesser total material thickness, compared to a comparison cross section that is shifted in the direction of the second face end, and thus in this vicinity they have increased flexibility. While in the exemplary embodiment of an attachment element 20, this thinning of material has been attained by reducing the outside diameter, the attachment element 30 is designed quite similarly to the attachment element 10. In the attachment element 30, the bore is merely not extended through the interior. The attachment element 40, although it does have an outside diameter that increases toward the first face end, is nevertheless provided with a markedly widened bore in the vicinity of that first face end, so that once again thinning of material is obtained, which leads to an increase in flexibility.

In principle, still further embodiments are conceivable. However, the embodiment of the attachment element 10 is preferred, especially since it is simple and easy to produce. Once the longitudinal bore has been made, it must be made widened toward the first face end in merely a single work step, typically in a metal-cutting operation, for instance by drilling or turning.

A change in the outside diameter, as the attachment elements 20 and 40 require, entails a higher machining cost.

Also from the above description of the exemplary embodiments, it should once again have become clear that with the attachment element of the invention and the associated possibility of reducing the stiffness of the connection to the inner tower wall and thus in particular the introduction of load surges or peak loads, there is a considerable advantage in the design and dimensioning of the tower wall and the determination in particular of the wall thickness, which expresses itself commercially in terms of economy of material as well as in other ways.

### LIST OF REFERENCE NUMERALS

1 Welded-in bushing
2 Central bore
3 Female thread
4 Weld seam
10 Attachment element
12 Central bore
13 Female thread
14 Portion
15 Wall
20 Attachment element
30 Attachment element
40 Attachment element
d Reduced wall thickness
D Wall thickness
l Length of portion with widened bore
L Total length
P Platform
S Screw
T Tower wall
W Angle element

1. An attachment element for fastening attachment parts (P) to a metal inner tower wall (T) of a tower of a wind energy system, comprising a first face end for being welded to the inner tower wall (T) and a second face end, facing the first face end, for fastening an attachment part (P), which attachment element, in the vicinity of the first face end, in cross section, has a total material thickness; in a cross section shifted in the direction of the second face end, is reduced compared to its overall material thickness.

2. The attachment element as defined by claim 1, having continuously constant outer dimensions from the first face end to the second face end and has a bore extending into the material in the longitudinal direction from the first face end.

3. The attachment element as defined by claim 2, having bushing-like form with a continuous longitudinal bore from the first face end to the second face end, and the longitudinal bore, in the vicinity of the first face end, has a portion with a widened diameter.

4. The attachment element as defined by claim 3, wherein the portion of the longitudinal bore with the widened diameter extends over at least one-third of the total length (L) of the attachment element measured from the first face end to the second face end.

5. The attachment element as defined by claim 1 wherein the second face end has a female thread.

6. The attachment element as defined by claim 1 which is cylindrical.

7. A tower of a wind energy system having a metal inner tower wall (T), and at least one attachment element as defined by claim 1 which is fastened on its first face end by welding to the inner tower wall (T).

8. The attachment element as defined by claim 2 wherein the second face end has a female thread.

9. The attachment element as defined by claim 3 wherein the second face end has a female thread.

10. The attachment element as defined by claim 4 wherein the second face end has a female thread.

11. The attachment element as defined by claim 2 which is cylindrical.

12. The attachment element as defined by claim 3 which is cylindrical.

13. The attachment element as defined by claim 4 which is cylindrical.

14. The attachment element as defined by claim 5 which is cylindrical.

15. The attachment element as defined by claim 8 which is cylindrical.

16. The attachment element as defined by claim 9 which is cylindrical.

17. The attachment element as defined by claim 10 which is cylindrical.

18. A tower of a wind energy system having a metal inner tower wall (T), and at least one attachment element as defined by claim 2 which is fastened on its first face end by welding to the inner tower wall (T).

19. A tower of a wind energy system having a metal inner tower wall (T), and at least one attachment element as defined by claim 3 which is fastened on its first face end by welding to the inner tower wall (T).

20. A tower of a wind energy system having a metal inner tower wall (T), and at least one attachment element as defined by claim 4 which is fastened on its first face end by welding to the inner tower wall (T).
